(19) United States
(12) Patent Application Publication
(10) Pub. No.: US 2024/0177189 A1
(43) Pub. Date: May 30, 2024

(54) IMAGE DATA ASSOCIATION METHOD, SYSTEM, APPARATUS AND RELATED COMPUTER PROGRAM PRODUCT

(71) Applicant: NexRetail Co., Ltd., Taipei (TW)

(72) Inventors: CHENG-HAN WU, Taipei (TW); FEI-TING CHEN, Taipei (TW); CHI-YEH HSU, Taipei (TW); YOU-GANG KUO, Taipei (TW)

(21) Appl. No.: 18/071,383

(22) Filed: Nov. 29, 2022

(51) Int. Cl. G06Q 30/0241; G06T 7/70; G06V 10/25; H04W 64/00

(52) U.S. Cl. CPC G06Q 30/0241; G06T 7/70; G06V 10/25; H04W 64/003

(57) ABSTRACT

An image data association method, system, apparatus, and related computer program product are provided. The method includes acquiring and recognizing an object in a first-view image of an area to identify a first position of the object; obtaining a second-view image corresponding to the area; converting the first position to a second position in the second-view image based on a spatial conversion relationship between the two images; acquiring positioning information regarding a signal transmission device from a radio frequency positioning system, the positioning information including device connectivity information; determining a third position of the signal transmission device in the second-view image according to the positioning information; determining whether the object is associated with the signal transmission device according to a distance between the second position and the third position; and associating the device connectivity information with the object when the object is associated with the signal transmission device.

### FIELD

The present disclosure is generally related to image data association method, system, apparatus, and related computer program product.

### BACKGROUND

E-Marketing is an important marketing method in today's business activities. Through the Internet, businesses can use various media to send promotional messages to consumers, such as sending product advertisements by email, sending product promotional messages via mobile device apps, and/or displaying product advertisements via web browsers.

Without knowing the identity of the consumer and without the consumer actively providing information about their interests, businesses cannot provide precise e-Marketing messages based on consumer preferences. In this case, businesses typically send a large number of various e-Marketing messages to non-specific consumers, so the e-Marketing messages are not marketing information for specific product types that the consumer prefers, which means that most marketing messages are unable to achieve the marketing goals. In other words, traditional e-Marketing sends a large number of unnecessary marketing messages, but cannot provide precise advertisement messages.

### SUMMARY

As demonstrated above, it is necessary to provide a method for precise e-Marketing.

According to an aspect of the present disclosure, a method of image data association is provided. The method includes obtaining a first-view image of an area; recognizing an object in the first-view image to identify a first position of the object in the first-view image; obtaining a second-view image corresponding to the area, the second-view image corresponding to a different perspective than the first-view image with respect to the area; converting the first position to a second position in the second-view image based on a spatial conversion relationship between the first-view image and the second-view image; acquiring, from a radio frequency positioning system, position information of a signal transmission device, the position information comprising device connectivity information of the signal transmission device; determining, a third position of the signal transmission device in the second-view image according to the position information; determining whether the object is associated with the signal transmission device according to a distance between the second position and the third position; and associating the device connectivity information with the object when the object is associated with the signal transmission device.

In an implementation, the method further includes associating the device connectivity information with advertisement identification information of the signal transmission device; and executing an advertisement transmission process to transmit an advertisement message to the signal transmission device based on the device connectivity information and the advertisement identification information.

In an implementation, the device connectivity information comprises a Media Access Control address of the signal transmission device.

In an implementation, the position information further includes signal measurement information that indicates a signal receiving strength of at least three radio frequency signal receivers in the radio frequency positioning system with respect to the signal transmission device.

In an implementation, the method further includes determining distance information of the at least three radio frequency signal receivers with respect to the signal transmission device based on the signal measurement information; and determining the third position of the signal transmission device in the second-view image based on the distance information.

In an implementation, the method further includes identifying the object from the first-view image based on an object identification process to generate a bounding box for the object; and determining the first position of the object in the first-view image according to the bounding box.

In an implementation, the second-view image is a planar layout image of the area.

According to another aspect of the present disclosure, a computer program product for image data association is provided. The computer program product includes at least one program instruction stored in a non-transitory computer-readable medium, and when the at least one program instruction is executed by a computer, the at least one program instruction causes the computer to perform the above-disclosed method of image data association. According to another aspect of the present disclosure, a non-transitory computer-readable medium is provided. The non-transitory computer-readable medium includes at least one program instruction that, when executed by a computer, causes the computer to perform the above-disclosed method of image data association.

According to another aspect of the present disclosure, a device for image data association is provided. The device includes a memory storing at least one program instruction; and a processing circuit coupled to the memory, wherein the at least one program instruction, when executed by the processing circuit, causes the device to perform the above-disclosed method of image data association.

According to another aspect of the present disclosure, a system for image data association is provided. The system includes an image capturing device configured to provide a first-view image of an area; a radio frequency positioning system configured to provide position information of a signal transmission device, the position information including device connectivity information of the signal transmission device; and a computational processing device coupled to the image capturing device and the radio frequency positioning system, and configured to recognize an object in the first-view image to identify a first position of the object in the first-view image; obtain a second-view image corresponding to the area, the second-view image corresponding to a different perspective than the first-view image with respect to the area; convert the first position to a second position in the second-view image based on a spatial conversion relationship between the first-view image and the second-view image; acquire the position information from the radio frequency positioning system; determine a third position of the signal transmission device in the second-view image according to the position information; determine whether the object is associated with the signal transmission device according to a distance between the second position and the third position; and associate the device connectivity information with the object when the object is associated with the signal transmission device.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a schematic diagram illustrating a system for image data association, according to an implementation of the present disclosure.

FIG. 2 is a flowchart illustrating a method for image data association, according to an implementation of the present disclosure.

FIG. 3 is a diagram illustrating a first-view image, according to an implementation of the present disclosure.

FIG. 4 is a diagram of a second-view image, according to an implementation of the present disclosure.

FIG. 5 is a diagram illustrating a spatial conversion relationship between a first-view image and a second-view image, according to an implementation of the present disclosure.

FIG. 6 is a flowchart illustrating an object detection/tracking algorithm, according to an implementation of the present disclosure.

FIG. 7 is a flowchart illustrating a matching algorithm, according to an implementation of the present disclosure.

FIG. 8 is a block diagram illustrating a computational processing device, according to an implementation of this disclosure.

### DESCRIPTION

Below, reference is made to the drawings for a detailed explanation of the implementations of this disclosure.

The following disclosure contains specific information pertaining to exemplary implementations in the present disclosure. The drawings and their accompanying detailed disclosure are directed to exemplary implementations. However, the present disclosure is not limited to these exemplary implementations. Other variations and implementations of the present disclosure will occur to those skilled in the art. Moreover, the drawings and illustrations are generally not to scale and are not intended to correspond to actual relative dimensions.

For consistency and ease of understanding, like features are identified by reference designators in the exemplary drawings. However, the features in different implementations may be different in other respects, and therefore shall not be narrowly confined to what is illustrated in the drawings.

The terms used in this disclosure are used only to describe specific examples and are not intended to limit the content of the disclosure. Unless specifically stated otherwise, the singular forms “one,” “said,” and “the” used herein also include the plural forms. The term “comprising,” “including,” or “having,” as used herein, indicates the presence of a feature, integer, step, operation, element, and/or component, but does not exclude the possibility of the presence or addition of one or more other features, integers, steps, operations, elements, components, and/or groups thereof.

The term “and/or” includes any and all combinations of one or more of the items listed related. Although the terms “first,” “second,” and “third,” etc. may be used herein to describe various components, elements, regions, layers and/or sections, these components, elements, regions, layers and/or sections should not be limited by these terms. These terms are used only to distinguish one component, element, region, layer, or section from another. Thus, a first component, element, region, layer, or section discussed below could be termed a second component, element, region, layer, or section without departing from the teachings of the present disclosure.

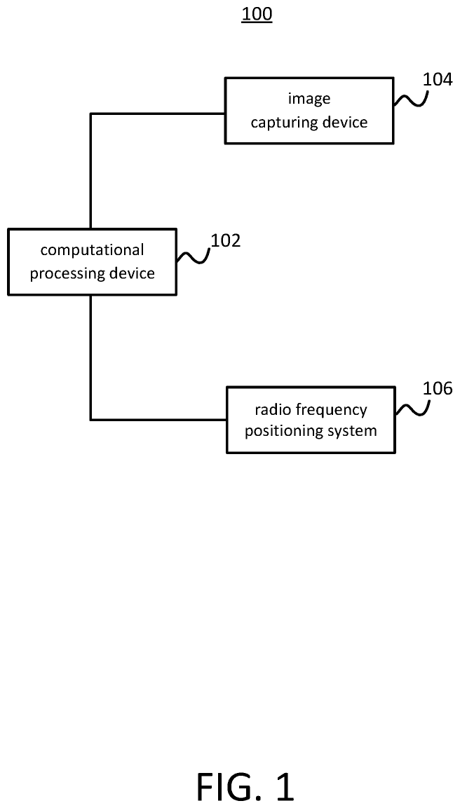

Referring to FIG. 1, FIG. 1 is a schematic diagram illustrating a system 100 for image data association, according to an implementation of the present disclosure. The system 100 may include, for example, a computational processing device 102, an image capturing device 104, and a radio frequency positioning system 106. The computational processing device 102 may be configured to perform various functions, algorithms, and actions described in the present disclosure to implement the method of image data association. The computational processing device 102 may be a computer, server, processor, circuit module, or other hardware device having data processing capability. The computational processing device 102 may be electrically connected to the image capturing device 104 and the radio frequency positioning system 106 via wired or wireless connection. The image capturing device 104 may capture or record an image of an area to generate one or more frames of a first-view image. The image capturing device 104 may be, for example, a camera, a surveillance camera, or other video generation/capture device with an image capture function. The radio frequency positioning system 106 may measure radio frequency signal strength from one or more specific devices and position these devices. For example, the radio frequency positioning system 106 may include multiple radio frequency receivers located at different positions in a specific region, the radio frequency receivers synchronously measure radio frequency signals from a signal transmission device and, based on a positioning algorithm (e.g., trilateration), determine the position of the signal transmission device. The signal transmission device may be, for example, a handheld/wearable electronic device (such as a smartphone) or other electronic device with a signal transmission function.

In some implementations, the computational processing device 102 may be integrated into the image capturing device 104 and/or the radio frequency positioning system 106 as a single hardware component. For example, the computational processing device 102 may be integrated into the image capturing device 104, so the image capturing device 104 is capable of edge computing functionality and able to perform the method of image data association as described in the present disclosure. In some implementations, the computational processing device 102, the image capturing device 104, and the radio frequency positioning system 106 may be used to refer (but not limited to) the computational processing device, the image capturing device, and the radio frequency positioning system mentioned in the implementations of the present disclosure.

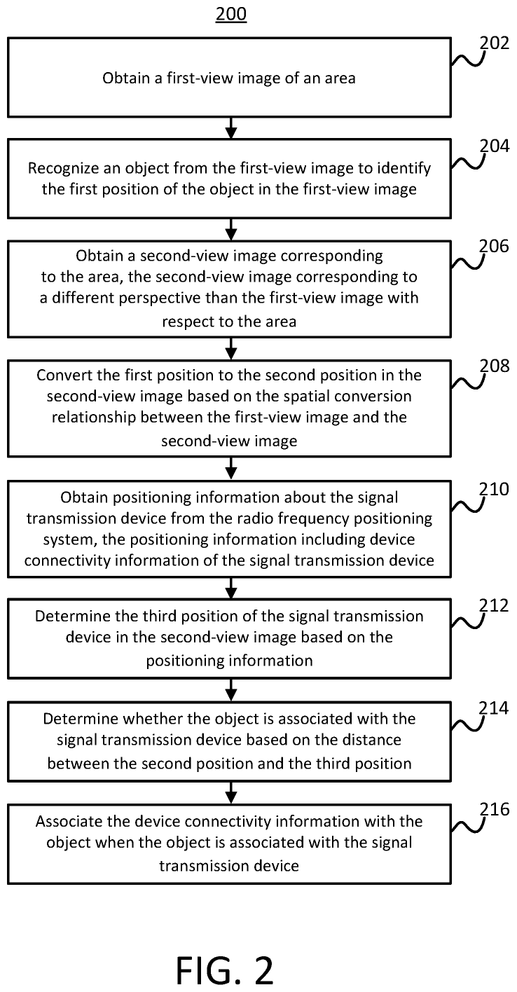

Referring to FIG. 2, FIG. 2 is a flowchart illustrating a method 200 for image data association, according to an implementation of the present disclosure. The method 200 may be performed, for example, by a computational processing device (such as the computational processing device 102 in FIG. 1).

In action 202, the computational processing device obtains a first-view image of an area. In some implementations, the computational processing device may obtain the first-view image from an image capturing device (such as the image capturing device 104 in FIG. 1), where the first-view image may be a static image or a frame image in dynamic video data. The area may be, for example, the shooting area of the image capturing device and may be, for example, an open space such as a mall, store, or other place for consumers.

In action 204, the computational processing device recognizes an object from the first-view image to identify a first position of the object in the first-view image. In some implementations, the computational processing device may recognize and track the object from the first-view image based on one or more object detection/tracking algorithms. The one or more object detection/tracking algorithms may include, for example, the You Only Look Once (YOLO) algorithm, the Simple Online and Realtime Tracking (SORT) algorithm, the Deep SORT algorithm, etc., but are not limited herein.

In some implementations, the computational processing device 102 may recognize the object from the first-view image based on an object detection algorithm and generate a bounding box corresponding to the object, thereby determining the first position of the object in the first-view image based on the bounding box. For example, the bounding box information may include parameters such as the length, width, coordinate, confidence score, and object feature name of the bounding box. The computational processing device can determine the first position based on the coordinate of the bounding box or the coordinate with an offset value added.

In action 206, the computational processing device obtains a second-view image corresponding to the area, the second-view image corresponding to a different perspective (or observation imaging plane) than the first-view image with respect to the area.

In some implementations, the computational processing device may store the second-view image in advance, where the second-view image is, for example, a planar layout image of the area (such as an aerial view of the inside of a store). In some implementations, the planar layout image may be a still photograph or a pre-drawn electronic image. In some implementations, the computational processing device may convert the first-view image into the second-view image based on a spatial conversion relationship and one or more image processing steps.

In action 208, the computational processing device converts the first position to a second position in the second-view image based on the spatial conversion relationship between the first-view image and the second-view image. For example, if the coordinate of the first position is (x1a, y1b), the computational processing device may calculate the coordinate of the second position (x2a, y2b) based on the following formula:

$$[ \begin{matrix}{x}_{2 a} \\ {y}_{2 b} \\ 1\end{matrix} ] = H [ \begin{matrix}{x}_{1 a} \\ {y}_{1 b} \\ 1\end{matrix} ] = [ \begin{matrix}h 00 & h 01 & h 02 \\ h 10 & h 11 & h 12 \\ h 20 & h 21 & h 22\end{matrix} ] [ \begin{matrix}{x}_{1 a} \\ {y}_{1 b} \\ 1\end{matrix} ] \qquad ( Formula 1 )$$

where the matrix H is used for converting a coordinate in the observation imaging plane of the first-view image to the corresponding coordinate in the observation imaging plane of the second-view image; the coefficients h00, h01, h02, h10, h11, h12, h20, h21, and h22 are the coordinate conversion coefficients for constituting the matrix H.

In action 210, the computational processing device obtains positioning information about a signal transmission device from a radio frequency positioning system (such as the radio frequency positioning system 106 in FIG. 1), where the positioning information includes device connectivity information of the signal transmission device.

The device connectivity information may include connectivity information of the signal transmission device at the Physical Layer and/or the Media Access Control (MAC) layer. For example, the device connectivity information may include the MAC address of the signal transmission device.

In action 212, the computational processing device determines a third position of the signal transmission device in the second-view image based on the positioning information.

In some implementations, the computational processing device may execute a positioning algorithm based on the positioning information to determine the third position of the signal transmission device in the second-view image. For example, the positioning information may further include signal measurement information indicating a signal receiving strength of at least three radio frequency signal receivers in the radio frequency positioning system relative to the signal transmission device. The signal receiving strength may be represented by indicators such as the Received Signal Strength Indication (RSSI) and the Reference Signal Receiving Power (RSRP). The computational processing device may determine distance information of the signal transmission device relative to the at least three radio frequency signal receivers based on the signal measurement information and determine the third position of the signal transmission device in the second-view image based on the distance information.

In some implementations, after the radio frequency positioning system obtains the signal receiving strength of different radio frequency signal receivers relative to the signal transmission device, the radio frequency positioning system further executes the positioning algorithm to estimate the position information of the signal transmission device and includes the position information to the positioning information for the computational processing device to determine the third position of the signal transmission device in the second-view image.

In action 214, the computational processing device determines whether the object is associated with the signal transmission device based on the distance between the second position and the third position.

In some implementations, when the computational processing device determines that the distance between the second position and the third position is less than or equal to a predetermined threshold, the computational processing device determines that the object corresponding to the second position (e.g., a consumer) is associated with the signal transmission device corresponding to the third position (e.g., the consumer's smartphone).

In some implementations, if the computational processing device obtains positioning information for multiple signal transmission devices from the radio frequency positioning system and marks multiple third positions corresponding to these signal transmission devices on the second-view image, the computational processing device may determine that one of these third positions (e.g. P1, P2, P3) that is closest to the second position (e.g. P0) is associated with the second position P0. In this case, the object corresponding to the second position P0 is determined to be associated with the signal transmission device corresponding to the third position P1. In some implementations, the computational processing device may further determine whether the distance between the second position P0 and the third position P1 is less than or equal to a predetermined threshold. If so, the object corresponding to the second position P0 is determined to be associated with the signal transmission device corresponding to the third position P1, thereby reducing the chance of misjudgment.

In action 216, the computational processing device associates the device connectivity information with the object when the object is associated with the signal transmission device.

In some implementations, the computational processing device may associate the device connectivity information with the object by organizing the device connectivity information and the object's attribute parameters into a specific data structure (e.g., table, field, entry, etc.). In some implementations, the computational processing device may associate the device connectivity information with the object by pointing to or including the device connectivity information in the object's bounding box information.

In some implementations, the computational processing device may associate the device connectivity information with an advertising identification information of the signal transmission device and execute an advertisement transmission process based on the device connectivity information and the advertisement identification information, so that the advertisement message is transmitted to the signal transmission device. The advertisement message may include, but is not limited to, commodity advertisement messages, commodity recommendation messages, group purchase notification messages, etc. The advertisement identification information includes, for example, one or more Advertisement Identities (AD IDs).

According to method 200, the computational processing device may obtain the device connectivity information associated with different consumers in the image, and thus obtain the information required for e-Marketing to consumers. Since the video image can fully present the behavior of different consumers in the mall, and the device connectivity information is associated with the consumer, the computational processing device can effectively identify the content in the image for precise e-Marketing.

It should be noted that although actions 202, 204, 206, 208, 210, 212, 214, 216 in FIG. 2 are represented by separate blocks, the arrangement order of these blocks is not used to limit the actual execution order of actions 202, 204, 206, 208, 210, 212, 214, 216. In some implementations, one or more of actions 202, 204, 206, 208, 210, 212, 214, 216 may be executed in parallel/simultaneously, or in the opposite order. For example, actions 202, 204, 206, 208 and actions 210, 212 can be executed in parallel and independently. In some implementations, the computational processing device can estimate the position of the signal transmission device in the first-view image (e.g., the fourth position) based on positioning information from the radio frequency positioning system and determine whether the object in the first-view image is associated with the signal transmission device based on the distance between the fourth position and the first position mentioned above. For example, when the computational processing device determines that the distance between the first position and the fourth position is less than or equal to a predetermined threshold, the computational processing device determines that the object corresponding to the first position (e.g., the consumer) is associated with the signal transmission device corresponding to the fourth position (e.g., the consumer's smartphone). Or, if the computational processing device obtains positioning information for multiple signal transmission devices from the radio frequency positioning system, and marks multiple fourth positions corresponding to these signal transmission devices on the first-view image, the computational processing device determines that a position (e.g., P1′) among the fourth positions (e.g. P1′, P2′, P3′) that is closest to the first position (e.g. P0′) is associated with the first position P0′. In this case, the object corresponding to the first position P0′ is determined to be associated with the signal transmission device corresponding to the fourth position P1′. In some implementations, the computational processing device may further determine that the distance between the first position P0′ and the fourth position P1′ is less than or equal to a predetermined threshold, and only then determines that the object corresponding to the first position P0′ is associated with the signal transmission device corresponding to the fourth position P1′, so as to reduce the chance of mistaken association.

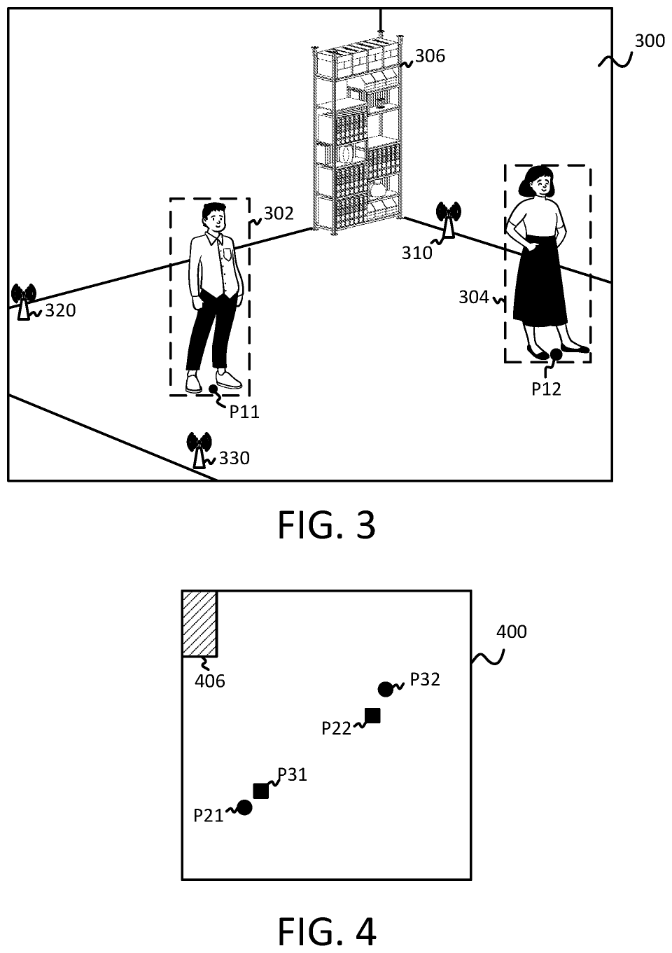

Referring to FIG. 3 and FIG. 4, FIG. 3 is a diagram illustrating a first-view image 300, according to an implementation of the present disclosure. FIG. 4 is a diagram of a second-view image 400, according to an implementation of the present disclosure.

In this implementation, the first-view image 300 is a three-dimensional perspective image of the interior of a store. The first-view image 300 may be taken by an image capturing device installed in the store. After the computational processing device obtains the first-view image 300, the computational processing device can recognize one or more objects, such as personnel 302 and personnel 304, from the first-view image 300 based on object detection/tracking algorithms. In some implementations, the objects recognized from the first-view image 300 are enclosed in a bounding box. The bounding box is represented by a dotted line in FIG. 3.

In some implementations, the computational processing device may further determine the coordinates of the object based on the bounding box or other identified object features. As shown in FIG. 3, the coordinates (e.g., corresponding to the above-mentioned first position) of personnel 302 and personnel 304 in the first-view image 300 are P11 and P12, respectively.

Please also refer to FIG. 4. The second-view image 400 is a plan layout of the interior of the above-mentioned store. Unlike the first-view image 300, the second-view image 400 is a bird's-eye view of the store, where the area 406 corresponds to the display area of the commodity shelf 306 in the first-view image 300.

Since the first-view image 300 and the second-view image 400 are planes obtained via imaging/drawing based on the three-dimensional perspective and a bird's-eye perspective, respectively, where a spatial conversion relationship is between the first-view image 300 and the second-view image 400, the computational processing device may convert the coordinates P11 and P12 in the first-view image 300 to the coordinates P21 and P22 in the second-view image 400 based on the spatial conversion relationship (e.g., by Formula 1). In other words, the coordinates P21 and P22 are used to respectively represent the positions (e.g., corresponding to the above-mentioned second position) of personnel 302 and personnel 304 in the second-view image 400.

In some implementations, a radio frequency positioning system is set up in the store, which includes a plurality of radio frequency signal receivers 310, 320, 330 that can be used to receive and measure radio frequency signals (e.g., WiFi signals, Bluetooth signals, or other paging signals, etc.) from different signal transmission devices (e.g., smartphones carried by personnel 302 and 304) and generate corresponding positioning information. For example, the radio frequency positioning system may detect and generate positioning information for the smartphone carried by the personnel 302 through the radio frequency signal receivers 310, 320, 330, where the positioning information may include the MAC address of the smartphone and the radio frequency signal strength (e.g., RSSI #1, RSSI #2, RSSI #3) measured by the radio frequency signal receivers 310, 320, 330 respectively from the smartphone. The radio frequency positioning system or the computational processing device may further calculate the coordinate (x, y) of the smartphone based on the following formula:

$$[ \begin{matrix}x \\ y\end{matrix} ] = {( {A}^{T} A )}^{- 1} {A}^{T} where \qquad ( Formula 2 )$$

$$A = [ \begin{matrix}2 {( {x}_{1} - {x}_{2} )}^{2} & 2 {( {y}_{1} - {y}_{2} )}^{2} \\ 2 {( {x}_{1} - {x}_{3} )}^{2} & 2 {( {y}_{1} - {y}_{3} )}^{2}\end{matrix} ]$$

$$b = [ \begin{matrix}{x}_{1}^{2} - {x}_{2}^{2} + {y}_{1}^{2} - {y}_{2}^{2} + {d}_{2}^{2} - {d}_{1}^{2} \\ {x}_{1}^{2} - {x}_{3}^{2} + {y}_{1}^{2} - {y}_{3}^{2} + {d}_{3}^{2} - {d}_{1}^{2}\end{matrix} ]$$

$$\{ \begin{matrix}{d}_{1} = \sqrt{{( {x}_{1} - x )}^{2} + {( {y}_{1} - y )}^{2}} \\ {d}_{2} = \sqrt{{( {x}_{2} - x )}^{2} + {( {y}_{2} - y )}^{2}} \\ {d}_{3} = \sqrt{{( {x}_{3} - x )}^{2} + {( {y}_{3} - y )}^{2}}\end{matrix}$$

where (x1, y1), (x2, y2), (x3, y3) represent the coordinates of radio frequency signal receivers 310, 320, 330, respectively; d1, d2, d3 represent the distance of radio frequency signal receivers 310, 320, 330 relative to the smartphone. d1, d2, d3 may, for example, be estimated based on the measured signal receiving strength RSSI #1, RSSI #2, RSSI #3 (or other signal strength indicators, such as RSRP).

In some implementations, the radio frequency signal receivers in the radio frequency positioning system are, for example, WiFi detection devices that detect the WiFi connection status of signal transmission devices located in a specific area, thereby obtaining positioning information corresponding to the signal transmission device.

As illustrated in FIG. 3 and FIG. 4, the computational processing device may determine that at least two signal transmission devices are in the store, located at the coordinates P31 and P32 (e.g., corresponding to the third position mentioned above). Since the coordinate positions P31 and P32 are close to the coordinates P21 and P22, the computational processing device may further determine that the signal transmission device at the coordinate P31 is associated with the object at the coordinate P21 (e.g., a smartphone carried by personnel 302), and that the signal transmission device at the coordinate P32 is associated with the object at the coordinate P22 (e.g., a smartphone carried by personnel 304).

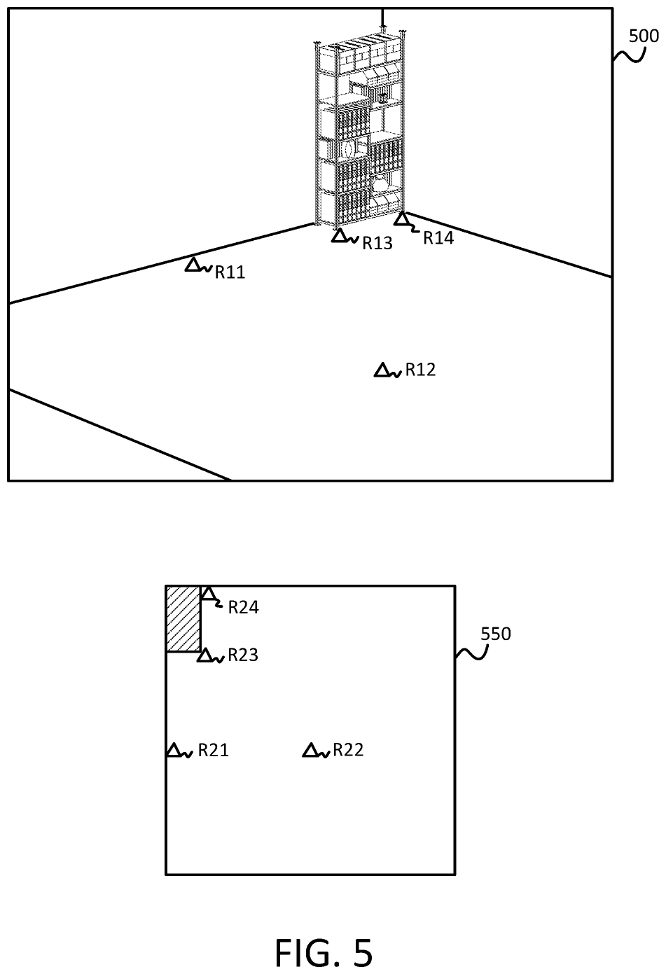

FIG. 5 is a diagram illustrating a spatial conversion relationship between a first-view image 500 and a second-view image 550, according to an implementation of the present disclosure. As shown in FIG. 5, reference points may be set at multiple specific positions in the shooting area in advance, and then the shooting area is photographed via the image capturing device to obtain the first-view image 500. For example, the coordinates of these reference points in the first-view image 500 are R11, R12, R13, R14, respectively. On the other hand, since the positions of these reference points are known, the coordinates of these reference points may be marked in the second-view image 550 corresponding to the shooting area (e.g., a plan layout of the shooting area) as R21, R22, R23, R24. Since the coordinates R11, R12, R13, R14 in the first-view image 500 correspond to the coordinates R21, R22, R23, R24 in the second-view image 550, the matrix H used for representing the spatial conversion relationship in Formula 1 can be calculated. In some implementations, the number of reference points set in the shooting area is greater than or equal to four.

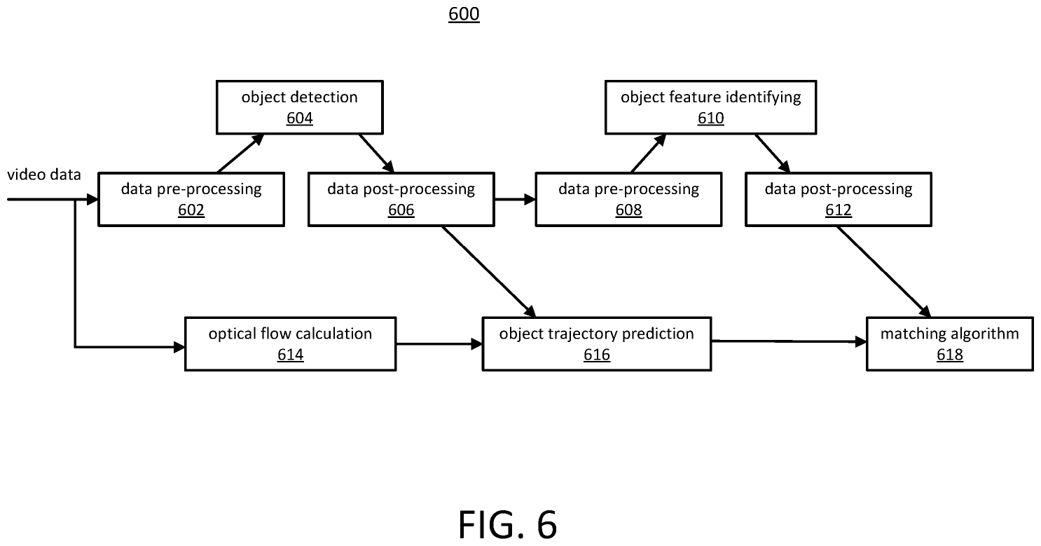

FIG. 6 is a flowchart illustrating an object detection/tracking algorithm 600, according to an implementation of the present disclosure. The computational processing device (e.g., the computational processing device 102 in FIG. 1) may execute the object detection/tracking algorithm 600 to identify and track objects from video data.

In action 602, the computational processing device performs data pre-processing on the video data from the image capturing device (e.g., the image capturing device 104 in FIG. 1). In some implementations, the data pre-processing includes, for example, normalizing images in multiple frames of the video data, so these images may have a consistent specific image size.

In action 604, the computational processing device detects one or more objects from the pre-processed video data. For example, the computational processing device may detect objects (e.g., personnel objects) in the images of each frame of the video data based on the YOLO algorithm and generate bounding boxes to mark the images of the objects.

In action 606, the computational processing device performs data post-processing on the detected object images. For example, after the computational processing device executes the object detection algorithm, the computational processing device may generate different bounding boxes for the same object in the image, where the bounding boxes may have different sizes and positions. Therefore, the computational processing device may select the most suitable one of these bounding boxes to represent the object via the data post-processing or average the positions and/or sizes of these bounding boxes to generate a bounding box for representing the object.

In action 608, the computational processing device performs data pre-processing on the output result of action 606. For example, the computational processing device may perform image normalization and color processing to avoid excessively bright or dark images.

In action 610, the computational processing device extracts object features (e.g., personnel object features) from the identified object images. In some implementations, the computational processing device may extract vectors of personnel object features up to 512-dimensions for subsequent similarity comparison.

In step 614, the computational processing processes the video data to calculate the optical flow. For example, the computational processing device calculates the instantaneous speed of the moving object (such as a consumer walking in a store) in the pixel motion on the observation imaging plane, and thus calculate the motion information presented between adjacent frames of the object. In some implementations, the computational processing device may use the pixel changes in the image sequence in the time domain and the correlations between adjacent frames to find the corresponding relationships between the previous frame and the current frame, and thus calculate the motion information of the object.

In step 616, the computational processing device performs object trajectory prediction. For example, the computational processing device may combine the Kalman filter and the Hungarian algorithm to predict the object's actions/trajectory.

In action 618, the computational processing device performs an object and trajectory matching algorithm. For example, the computational processing device may compare the similarity of object features and calculate the intersection over union (IOU) of the prediction result of the Kalman filter and the bounding box position and combine the similarity results and IOU calculation for matching the object trajectory with the bounding box.

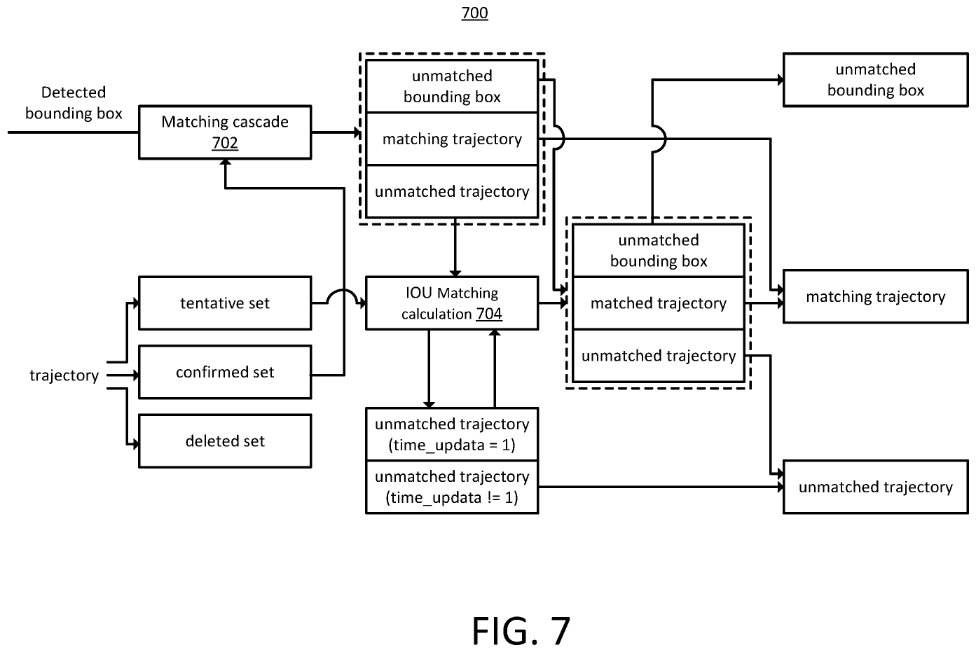

FIG. 7 is a flowchart illustrating a matching algorithm 700, according to an implementation of the present disclosure. The computational processing device (e.g., the computational processing device 102 in FIG. 1) may perform the matching algorithm 700 to match the object and trajectory, thereby realizing object tracking of video data. In some implementations, the matching algorithm 700 may correspond to action 618 in the object detection/tracking algorithm 600 of FIG. 6.

In action 702, the computational processing device performs an appearance-based matching cascade, that is, by comparing the appearance similarity of the detected bounding box and the trajectory, to determine whether they match. If the appearance of the detected bounding box and the trajectory are matched, the appearance-similar bounding box and the trajectory are regarded as a matching trajectory, and the information of the bounding box is added to the trajectory. In some implementations, the information of the bounding box includes the length, width, coordinate, confidence score, and object name of the bounding box.

In action 704, the computational processing device performs an IOU matching calculation on the positions of the detected bounding boxes and trajectories. The higher the overlap between the two, the higher the IOU value, which indicates a better match. The computational processing device may determine that the bounding boxes and trajectories that are matched as a matching trajectory. For bounding boxes that are not matched by the appearance-based matching cascade and IOU matching calculation, the computational processing device may assign them a new trajectory. For trajectories that are not matched, those trajectories are not present in the image at the moment, and in this case, those trajectories are placed in the historical trajectory set. In some implementations, the historical trajectory set can be divided into three categories: the tentative set, the confirmed set, and the deleted set. In some implementations, the computational processing device is configured with a parameter (e.g., time_update) and when the parameter is set to a first value (e.g., time update=1), it indicates that the trajectory has just been updated (e.g., the object detected in the previous frame also appears in the current frame), and if time update !=1, it means that the trajectory has not been updated (e.g., the object detected in the previous frame does not appear in the current frame). With such manner, whether the detected object in the image is continuously appeared or have not appeared in the image for some time may be distinguished. If the object has not appeared in the image for some time, it is not necessary to perform an IOU matching calculation.

In some implementations, the computational processing device may recognize at least one person's behavior in the video data. For example, if the image taken by the image capturing device includes the image of a consumer, the computational processing device can recognize the consumer's behavior through a previously stored or trained person behavior recognition model. In some implementations, the behavior may be a fetching behavior, a gaze behavior, or other behaviors made by the consumer towards a specific product. The computational processing device may initiate an advertisement transmission process based on the recognized behavior, and thus transmits advertisement messages related to the specific product to the consumer's signal transmission device (e.g., smartphone).

In some implementations, the computational processing device may obtain the advertisement identification information of the signal transmission device via a mobile device application and/or a web browser and transmit advertisement messages about a specific product type to the signal transmission device via the advertisement identification information. For example, after the consumer downloads a mobile device application related to a certain merchant to the smartphone, the computational processing device may obtain the corresponding advertisement identification for the consumer, so that the mobile device application can provide relevant advertisement messages to the smartphone. The computational processing device may also transmit the advertisement message to the smartphone via the web browser when the consumer visits the merchant's related website.

In some implementations, the computational processing device may create and/or store a recognition module for human behavior through deep learning methods. The recognition module may be created by the computational processing device or an external device via deep learning methods and stored in the computational processing device. The deep learning method may be an algorithm based on artificial neural networks that include three layers: an input layer, a hidden layer, and an output layer. In the input layer, the artificial neural network may receive multiple reference image data, such as action information of at least one person's hand joint nodes, standing orientation information of the person, and/or skeleton information of the person, etc. In the output layer, expected results may be set, such as, but not limited to: picking up actions, attention range, etc. After multiple learning sessions, the parameters in the hidden layer may be extracted and used to create a recognition module for identifying human behavior.

By identifying consumer behavior, the content or timing of the advertisement messages transmitted to consumers is optimized. For example, when the computational processing device recognizes from its own video data that the consumer is looking at or picking up a certain type of product, the computational processing device determines that the consumer may have a higher interest in that type of product. The computational processing device can obtain the required information (such as advertisement identification information) for transmitting an advertisement to the consumer based on the device connectivity information associated with the consumer and thus transmit an advertisement message for that type of product to the consumer through a platform corresponding to the advertisement identification information (such as Facebook or Google), thereby achieving precise e-Marketing.

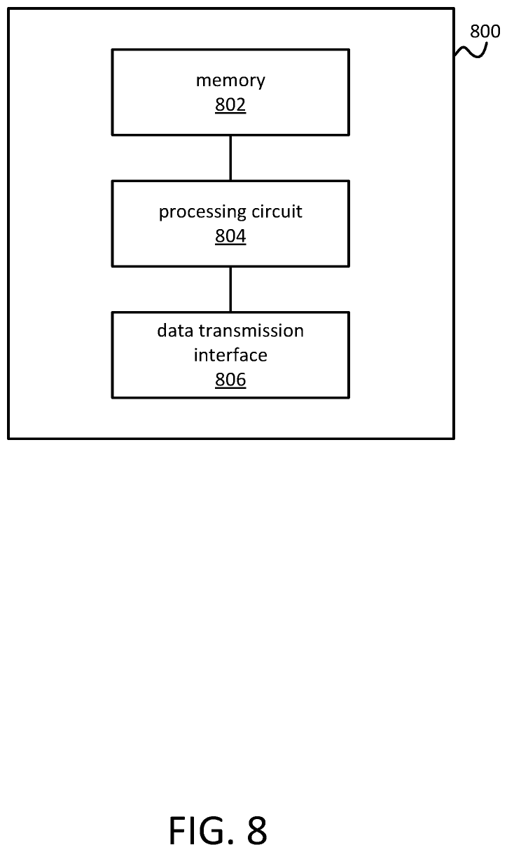

FIG. 8 is a block diagram illustrating a computational processing device 800, according to an implementation of this disclosure. The computational processing device 800 may be configured as the computational processing device mentioned in the various implementations of the present disclosure. The computational processing device 800, for example, includes a memory 802 storing at least one program instruction and a processing circuit 804 coupled to the memory 802. The processing circuit 804 is configured to perform a method for image data association as mentioned in the present disclosure when the processing circuit 804 executes the at least one program instruction.

In some implementations, the computational processing device 800 further includes a data transmission interface 806 that serves as a medium for signal communication between the computational processing device 800 and external devices or components.

The present disclosure provides a computer program product for image data association, the computer program product including a computer program stored on a non-transitory computer-readable storage medium, the computer program comprising at least one program instruction that, when the at least one program instruction is executed by a computer, causes the computer to perform the method, actions, and/or functions of the image data association as mentioned above. The present disclosure also provides a non-transitory computer-readable storage medium that includes at least one program instruction that, when the at least one program instruction is executed by a computer, the at least one program instruction causes the computer to perform the method, actions, and/or functions of the image data association as mentioned above. The non-transitory computer-readable storage medium may include, for example, a non-transitory magnetic medium (such as a hard disk, a floppy disk, etc.), a non-transitory optical medium (such as a CD, a digital video disc, a blue-ray disc, etc.), a non-transitory semiconductor medium (such as a flash memory, an erasable programmable read-only memory (EPROM), an electrically-erasable programmable read-only memory (EEPROM), etc.), any suitable medium that does not have a transient or temporary representation during transmission, and/or any suitable tangible medium. As another example, a transitory computer-readable storage medium may include signals in a network, a wire, a conductor, an optical fiber, a circuit, and any suitable medium that has a transient or temporary representation during transmission, and/or any suitable intangible medium.

The present disclosure also provides a system for image data association, the system including an image capturing device, a radio frequency positioning system, and a computational processing device electrically connected to the image capturing device and the radio frequency positioning system. The image capturing device provides a first-view image of an area. The radio frequency positioning system provides positioning information about a signal transmission device, where the positioning information includes device connectivity information of the signal transmission device. The computational processing device is configured to: recognize an object from the first-view image to identify a first position of the object in the first-view image; obtain a second-view image corresponding to the area, the second-view image corresponding to a different perspective from the first-view image in the area; convert the first position to a second position in the second-view image based on a spatial conversion relationship between the first-view image and the second-view image; obtain the positioning information from the radio frequency positioning system; determine a third position of the signal transmission device in the second-view image based on the positioning information; determine whether the object is associated with the signal transmission device based on a distance between the second position and the third position; and associate the device connectivity information with the object when the object is associated with the signal transmission device.

The above examples of the present disclosure have been described in detail with reference to the accompanying drawings, but the specific composition is not limited to these examples and includes design changes within the scope of the purpose of the present disclosure. In addition, the present disclosure can be variously modified within the scope of the patent application, and the implementation forms obtained by appropriately combining the technical means separately disclosed in different implementation forms are also included within the technical scope of the present disclosure. In addition, it also includes the composition obtained by exchanging elements that have the same effect as the elements described in the above-mentioned examples.

What is claimed is:

1. A method of image data association, the method comprising:
obtaining a first-view image of an area;
recognizing an object in the first-view image to identify a first position of the object in the first-view image;
obtaining a second-view image corresponding to the area, the second-view image corresponding to a different perspective than the first-view image with respect to the area;
converting the first position to a second position in the second-view image based on a spatial conversion relationship between the first-view image and the second-view image;
acquiring, from a radio frequency positioning system, position information of a signal transmission device, the position information comprising device connectivity information of the signal transmission device;
determining a third position of the signal transmission device in the second-view image according to the position information;
determining whether the object is associated with the signal transmission device according to a distance between the second position and the third position; and
associating the device connectivity information with the object when the object is associated with the signal transmission device.

2. The method of claim 1, further comprising:
associating the device connectivity information with advertisement identification information of the signal transmission device; and
executing an advertisement transmission process to transmit an advertisement message to the signal transmission device based on the device connectivity information and the advertisement identification information.

3. The method of claim 1, wherein the device connectivity information comprises a Media Access Control address of the signal transmission device.

4. The method of claim 1, wherein the position information further comprises signal measurement information that indicates a signal receiving strength of at least three radio frequency signal receivers in the radio frequency positioning system with respect to the signal transmission device.

5. The method of claim 4, further comprising:
determining distance information of the at least three radio frequency signal receivers with respect to the signal transmission device based on the signal measurement information; and
determining the third position of the signal transmission device in the second-view image based on the distance information.

6. The method of claim 1, further comprising:
identifying the object from the first-view image based on an object identification process to generate a bounding box for the object; and
determining the first position of the object in the first-view image according to the bounding box.

7. The method of claim 1, wherein the second-view image is a planar layout image of the area.

8. A device for image data association, the device comprising:
a memory storing at least one program instruction; and
a processing circuit coupled to the memory, wherein the at least one program instruction, when executed by the processing circuit, causes the device to:
obtain a first-view image of an area;
recognize an object in the first-view image to identify a first position of the object in the first-view image;
obtain a second-view image corresponding to the area, the second-view image corresponding to a different perspective than the first-view image with respect to the area;
convert the first position to a second position in the second-view image based on a spatial conversion relationship between the first-view image and the second-view image;
acquire, from a radio frequency positioning system, position information of a signal transmission device, the position information comprising device connectivity information of the signal transmission device;
determine a third position of the signal transmission device in the second-view image according to the position information;
determine whether the object is associated with the signal transmission device according to a distance between the second position and the third position; and
associate the device connectivity information with the object when the object is associated with the signal transmission device.

9. The device of claim 8, wherein the at least one program instruction, when executed by the processing circuit, further causes the device to:
associate the device connectivity information with advertisement identification information of the signal transmission device; and
execute an advertisement transmission process to transmit an advertisement message to the signal transmission device based on the device connectivity information and the advertisement identification information.

10. The device of claim 8, wherein the device connectivity information comprises a Media Access Control address of the signal transmission device.

11. The device of claim 8, wherein the position information further comprises signal measurement information that indicates a signal receiving strength of at least three radio frequency signal receivers in the radio frequency positioning system with respect to the signal transmission device.

12. The device of claim 11, wherein the at least one program instruction, when executed by the processing circuit, further causes the device to:
determine distance information of the at least three radio frequency signal receivers with respect to the signal transmission device based on the signal measurement information; and
determine the third position of the signal transmission device in the second-view image based on the distance information.

13. The device of claim 8, wherein the at least one program instruction, when executed by the processing circuit, further causes the device to:
identify the object from the first-view image based on an object identification process to generate a bounding box for the object; and
determine the first position of the object in the first-view image according to the bounding box.

14. The device of claim 8, wherein the second-view image is a planar layout image of the area.

15. A non-transitory computer-readable medium comprising at least one program instruction that, when executed by a computer, causes the computer to:
obtain a first-view image of an area;
recognize an object in the first-view image to identify a first position of the object in the first-view image;
obtain a second-view image corresponding to the area, the second-view image corresponding to a different perspective than the first-view image with respect to the area;
convert the first position to a second position in the second-view image based on a spatial conversion relationship between the first-view image and the second-view image;
acquire, from a radio frequency positioning system, position information of a signal transmission device, the position information comprising device connectivity information of the signal transmission device;
determine a third position of the signal transmission device in the second-view image according to the position information;
determine whether the object is associated with the signal transmission device according to a distance between the second position and the third position; and
associate the device connectivity information with the object when the object is associated with the signal transmission device.

16. The non-transitory computer-readable medium of claim 15, wherein the at least one program instruction, when executed by the computer, further causes the computer to:
associate the device connectivity information with advertisement identification information of the signal transmission device; and
execute an advertisement transmission process to transmit an advertisement message to the signal transmission device based on the device connectivity information and the advertisement identification information.

17. The non-transitory computer-readable medium of claim 15, wherein the device connectivity information comprises a Media Access Control address of the signal transmission device.

18. The non-transitory computer-readable medium of claim 15, wherein the position information further comprises signal measurement information that indicates a signal receiving strength of at least three radio frequency signal receivers in the radio frequency positioning system with respect to the signal transmission device.

19. The non-transitory computer-readable medium of claim 18, wherein the at least one program instruction, when executed by the computer, further causes the computer to:
determine distance information of the at least three radio frequency signal receivers with respect to the signal transmission device based on the signal measurement information; and
determine the third position of the signal transmission device in the second-view image based on the distance information.

20. The non-transitory computer-readable medium of claim 15, wherein the second-view image is a planar layout image of the area.
